(19) United States
(12) Patent Application Publication
(10) Pub. No.: US 2003/0012856 A1
(43) Pub. Date: Jan. 16, 2003

(54) Automated process for preparing stuffed squid

(75) Inventor: Bruno Cruz Mesquita Bastos de Sousa, Lisboa (PT)

Correspondence Address: HELLER EHRMAN WHITE & MCAULIFFE LLP, 275 MIDDLEFIELD ROAD, MENLO PARK, CA, 94025-3506, US

(73) Assignee: Bruno Cruz Mesquita Bastos de Sousa

(21) Appl. No.: 09/895,800

(22) Filed: Jun. 29, 2001

(51) Int. Cl. A23G 1/00

(52) U.S. Cl. 426/282

(57) ABSTRACT

The present invention relates to an automated process for preparing stuffed squid. It is essentially characterized by the following stages:—receipt of the new materials;—preparation of the stuffing and cleaning of the squid;—stuffing;—finishing and transportation for freezing;—freezing;—glazing;—packing;—storage and shipping of the product. The stuffing stage is carried out at an average temperature of between 7 and 11° C. and a squid stuffing machine is used consisting of four stuffing dosing devices, where the squid is placed manually.

### BACKGROUND OF THE INVENTION

Stuffed squid are already available on the market. However, their manufacturing process is essentially manual, with all the inconveniences that this involves.

It is known that the preparation of stuffed squid is a lengthy process, which is rather complicated and requires a very specific structuring. In fact, it is necessary among other things to go through various stages in the preparation of the squid to be stuffed in order to leave the tubular part empty, prepare the stuffing, cook the stuffing, stuff the squid and close the “tubes” of the squid that has been stuffed.

When this process is carried out in the home all of these stages are fairly simple owing to the small quantities to be prepared, generally for immediate consumption, but on an industrial scale the whole process is more complicated. In fact, there are factors to be considered in an industrial process which are not taken into account when the process is carried out in the home, as they are not necessary or simply due to a lack of resources.

It can generally be said that the stuffed squid on sale on the market is produced industrially using processes that are carried out in the home, where the only adjustment made is the number of people processing the squid.

These processes cannot be very profitable and, worse still, they generally do not comply with the minimum hygiene requirements or the requirements necessary in order to guarantee that the finished product is of a high quality.

In fact, as well as well-defined hygiene conditions for industrial food handling processes, there are technical requirements which must be met, for example the requirements relating to the temperature of the mixture of products which are subsequently frozen for sale to the public must be observed, or the pressure for stuffing the squid “tubes” in order to ensure a uniform stuffing. In the case of the mixture of products at very different temperatures, such as the squid with a handling temperature of 5-7° C. with the cooked stuffing at a temperature of over 70° C., this could have disastrous consequences, for example if the stuffed squid is to be frozen for subsequent sale to the public.

### SUMMARY OF THE INVENTION

This invention intends to resolve or minimize the inconveniences described above.

One of the objectives of this invention is the almost complete automation of all the stages of the process for preparing the squid, which in principle will guarantee increased profitability.

Another objective of the invention consists of using hygiene and technical standards which guarantee a finished product acceptable to consumers.

In order to meet the objectives proposed, the invention describes a process which is essentially characterized by the following stages: receipt of the raw materials;—preparation of the stuffing and cleaning of the squid;—stuffing;—finishing and transportation for freezing;—freezing;—glazing;—packing;—storage and shipping of the product. The stuffing stage is carried out at an average temperature of between 7 and 11° C. and a squid stuffing machine is used consisting of four dosing devices, where the squid is placed manually.

The other objectives and characteristics will be understood more easily in the description given hereunder.

### BRIEF DESCRIPTION OF THE INVENTION

In order to facilitate the detailed description of the invention given hereunder, a sheet of drawings is attached, which is merely intended as an example and is not restrictive in any way and in which:

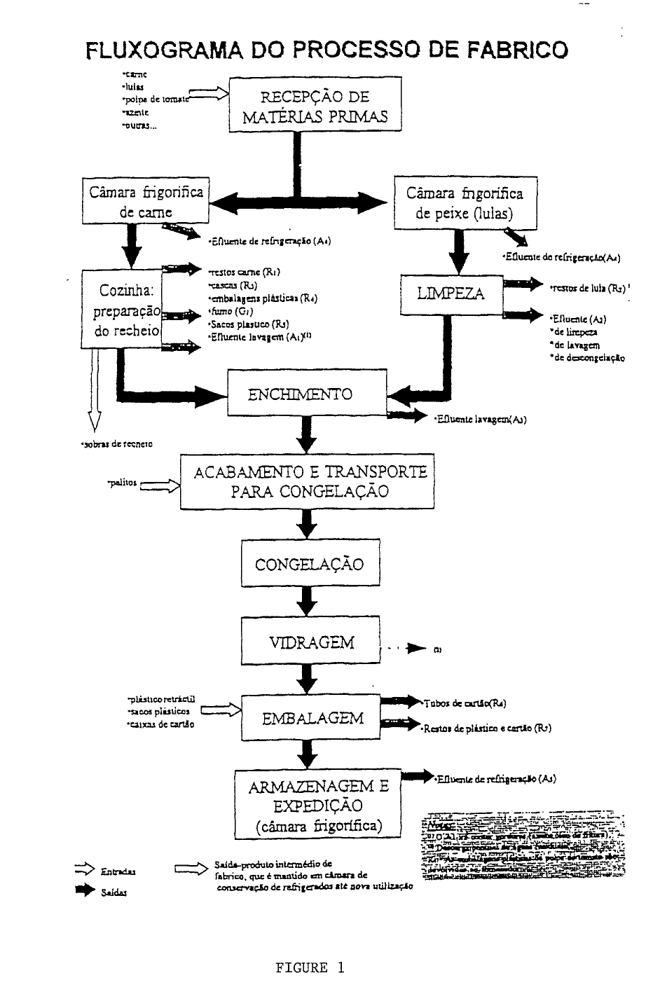

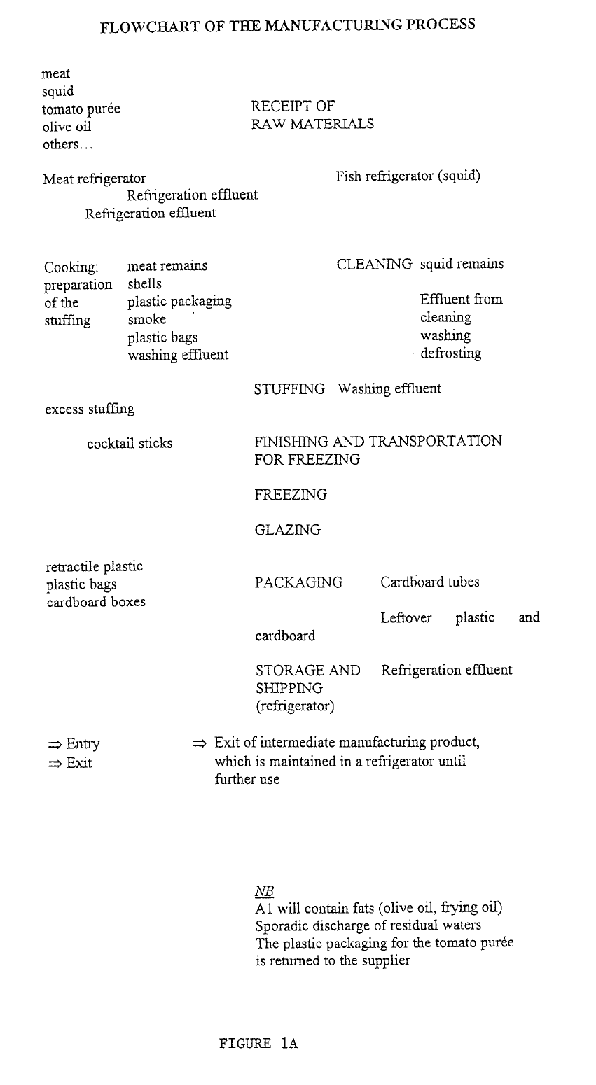

FIG. 1 represents a flowchart of the manufacturing process.

### DETAILED DESCRIPTION OF THE INVENTION

As can be seen from the figure, the automated process is essentially characterized in that it comprises the following stages:

receipt of the raw materials, squid and meat, frozen or refrigerated, among other things;

preparation of the stuffing by chopping the ingredients, which are then gently fried;

cleaning of the squid by immersing the frozen or fresh squid in a container of water at a regulated temperature of 5-7° C., after which they are sent to a semi-automatic cleaning line where their skin, heads and tentacles are removed and they are then washed with water;

stuffing, whereby the squid tubes are filled with a stuffing that has been prepared beforehand;

finishing and transportation for freezing whereby the squid tube is closed manually or automatically using appropriate means;

freezing by spraying the squid with liquid nitrogen at a temperature of around −196° C. in a nitrogen tunnel, thus making it possible to maintain all the natural and organoleptic qualities of the product practically unaltered;

glazing of the squid by immersing them in a bath of water equipped with an oxygen injection system in order to remove bacteria from the water and keep it pure;

packing and storage in refrigerators.

The squid and meat arrive at the factory duly frozen or fresh and are stored in refrigerators while they wait to be used at −25° as a frozen product or 2 to 4° C. as a fresh product.

The second stage, when the stuffing is prepared, is carried out in cooking vessels, preferably three, where all the ingredients of the stuffing are gently fried according to a predefined recipe (normally consisting of minced meat, tomato puree, chopped onion, flavourings, etc.), and after cooking the stuffing is transferred to a cooling vessel of suitable dimensions where, using C0₂, it is cooled down to a temperature of between 7 and 11° C. This cooling down process is absolutely indispensable in order to prevent a thermal shock when the squid “tubes” are stuffed. In fact, without this cooling down process the stuffing will come into contact with the squid at a temperature of around 5-7° C., which could destroy the organoleptic qualities of the finished product and speed up the decomposition process

After the cooling down process, the stuffing is pumped into the stuffing line using a pump which guarantees that it maintains the individual characteristics of some of its components, without the appearance of a homogenous paste. The choice of pump is an important factor. In fact, too much pressure can cause the characteristics of the products used in the stuffing to cease to be differentiated, in terms of both visual appearance and their taste.

The stage of the stuffing of the squid tubes is carried out in an appropriate place where, by means of a conveyor belt, the clean squid (tubes) and the stuffing prepared beforehand are sent simultaneously. The insertion of the stuffing in the tubes is carried out using dosing guns which distribute the stuffing at a pressure of around 50 bars. These dosing guns are connected to a suitable device. The positioning of the squid tube in the dosing gun is carried out manually. In order to avoid safety risks, the pressure of the stuffing machine is controlled by means of several sensors. Thus, the stuffing device is equipped with an appropriate number of pressure sensors placed in the receptacle in which the stuffing is inserted, in order ot ensure that the pressure is maintained at a constant level while the squid are being stuffed, even if one or more stuffing distribution guns stop working because they are not activated by their operator.

Once they have been filled, the squid tubes are closed manually, normally using a cocktail stick, and they undergo various simple operations such as laying, which allows them to be stored and reduces the volume that the product occupies, and they are then transported to the nitrogen tunnel where the freezing process will take place.

Said freezing process is carried out using liquid nitrogen (cryogenics) in a liquid nitrogen tunnel. The squid arrive at the tunnel on a conveyor belt, they are transported along said tunnel and sprayed with liquid nitrogen by suitable injectors situated inside the tunnel, at a temperature of −196° C. The natural and organoleptic qualities of the product are maintained virtually unaltered.

After freezing, the product (the stuffed squid) undergoes a glazing process carried out by immersion in a bath of water. In order to remove the bacteria from the water, this bath is fitted with an oxygen injections system, this maintaining the purity of the water. In a continuous manner the stuffed squid comes out of the glazing bath with a protective glazed coating (between 2% and 5% of water in relation to the

$$product - 2 \% < \frac{Wglazing}{Wproduct} < 5 \%$$

The finished product (frozen and glazed) is then transported on a conveyor belts to the packing tables, where it is put in plastic bags of different volumes and then packed inside various types of boxes for different quantities. These stages use support equipment in order to automate the process, in particular a vertical packer to pack the product in bags, an automatic machine to make up the cardboard boxes, an automatic machine to close the cardboard boxes and a palletising machine.

Finally, the product is stored in refrigerators at −25° C. in order to keep the product frozen in the best conditions possible. The duly stored product is stacked a stainless steel shelf with the correct number of packages in order to control the conditions of hygiene and health and comply with the most stringent health requirements for the fresh products, which are refrigerated at 2° to 4° C.

The whole process takes place in a factory with a food handling area where the temperature is maintained at 8° to 11° C., according to a plan which has been devised beforehand. Thus, the various stages of the process are carried out in sequence in order to guarantee a rapid flow.

As can be understood from the description given above, the automated process for preparing stuffed squid not only uses equipment, tools and utensils which ensure that the legal regulations for the preparation of food are met, but it also employs means to improve the conditions of hygiene and health.

The description given above must not be considered to be of a restrictive nature. As will be obvious to specialists in this field, various alterations are possible. The invention should only be limited by the spirit and scope of the following claims.

1. An automated process for preparing stuffed squid, characterized in that it comprises the following stages:
receipt of the raw materials, squid and meat, frozen or fresh, among other things;
preparation of the stuffing by chopping the ingredients, which are then gently fried;
cleaning of the squid by immersing the frozen or fresh squid in a container of water at a temperature of 5-7° C., after which they are sent to a semi-automatic cleaning line where their skin, heads and tentacles are removed and they are then washed with water;
stuffing, whereby the squid tubes are filled with a stuffing that has been prepared beforehand, the squid stuffing stage being carried out at an average temperature of between 7 and 11° C.
finishing and transportation of freezing whereby the squid tube is closed manually or automatically using appropriate means;
freezing by spraying the squid with liquid nitrogen at a temperature of around −196° C. in a nitrogen tunnel, thus making it possible to maintain all the natural and organoleptic qualities of the product practically unaltered;
glazing of the squid by immersing them in a bath of water equipped with an oxygen injection system in order to remove bacteria from the water and keep it pure; 2%<Wglazing/Wproduct <5%
packing and storage in refrigerators for frozen products at −25° C. and fresh products at 2° to 4° C.

2. An automated process for preparing stuffed squid, according to the previous claim, characterized in that the stage for the preparation of the stuffing is carried out in cooking vessels, preferably three, where all the ingredients of the stuffing are gently fried according to a predefined recipe, and after cooking the stuffing is transferred to a cooling vessel of suitable dimensions where, by injecting C0₂, it is cooled down to a temperature of between 7 and 11° C.

3. An automated process for preparing stuffed squid, according to claim 1, characterized in that after the cooling down process the stuffing is pumped into the stuffing line using a pump which guarantees that it maintains the individual characteristics of some of its components, without the appearance of a homogenous paste.

4. An automated process for preparing stuffed squid, according to claim 1, characterized in that the stuffing process is carried out using dosing guns which distribute the stuffing at a pressure of around 50 bars, said guns being connected tot he stuffing machine fitted with a pre-programmable stuffing device.

5. An automated process for preparing stuffed squid, according to claim 4, characterized in that the stuffing device is equipped with an appropriate number of pressure sensors placed in the receptacle in which the stuffing is inserted, in order to ensure that the pressure is maintained at a constant level while the squid is being stuffed, even if one or more stuffing distribution guns stop working because they are not activated by their operator.

6. An automated process for preparing stuffed squid, according to claim 1, characterized in that the squid pass through the various processing stages along continuous conveyor belts and also in that the products are not mixed.
